(19) United States
(12) Patent Application Publication
(10) Pub. No.: US 2025/0046017 A1
(43) Pub. Date: Feb. 6, 2025

(54) VIRTUAL TRY-ON SYSTEM, VIRTUAL TRY-ON METHOD, AND RECORDING MEDIUM

(71) Applicant: NEC Corporation, Minato-ku, Tokyo (JP)

(72) Inventor: Yuya OSHIRO, Tokyo (JP)

(73) Assignee: NEC Corporation, Minato-ku, Tokyo (JP)

(21) Appl. No.: 18/719,918

(22) PCT Filed: Aug. 9, 2023
(86) PCT No.: PCT/JP2023/029020

§ 371 Date: Jun. 14, 2024

(30) Foreign Application Priority Data
Aug. 25, 2022 (JP) 2022-134306

(51) Int. Cl. G06T 19/00; G06V 20/60

(52) U.S. Cl. CPC G06T 19/00; G06V 20/60; G06T 2200/24; G06T 2210/16

(57) ABSTRACT

A virtual try-on system according to an aspect of the present disclosure includes: at least one memory configured to store instructions; and at least one processor configured to execute the instructions to: acquire a person image of a person performing virtual trying-on; receive designation of an article; receive a selection of a wearing mode for the article; select an article image indicating the selected wearing mode from among a plurality of article images each indicating a different wearing mode for the article; and output, based on the person image and the selected article image, an output image including a wearing image indicating the article when the article is worn by the person in the selected wearing mode.

### TECHNICAL FIELD

The present disclosure relates to a virtual try-on system and others.

### BACKGROUND ART

A mirror is provided in a store that sales fashion items such as clothes and accessories. The mirror is utilized by a customer to put a product on the body and determine whether the product is suitable. In recent years, a virtual try-on system practically using a digital signage and augmented reality has been utilized. The virtual try-on allows a customer to easily try various products and color variations of the products.

As an example of a system allowing virtual try-on, PTL 1 discloses a system in which a half mirror is provided on a display surface side of an image display panel. In PTL 1, the image display panel displays a clothing image in a superposed manner on a mirror image of a user, which is seen on the half mirror. PTL 1 further discloses that the image display panel displays an image of the user and the clothing image in a combined manner.

### CITATION LIST

### Patent Literature

PTL 1: WO 2017/090345 A1

### SUMMARY OF INVENTION

### Technical Problem

Depending on an article, it is possible to wear the article in various wearing modes. For example, it is possible to wear a shirt by fastening a button, or over another cloth by unfastening a button. In PTL 1, wearing one article in various wearing modes is not disclosed. Therefore, virtual trying-on in only one wearing mode has been allowed, and it may have been difficult to determine whether the article is suitable for the person.

An object of the present disclosure is to provide a virtual try-on system and others that facilitate determination of whether an article is suitable for a person.

### Solution to Problem

A virtual try-on system according to the present disclosure includes: a person image acquisition means for acquiring a person image of a person performing virtual trying-on; an article reception means for receiving designation of an article; a wearing mode reception means for receiving a selection of a wearing mode for the article; an article image selection means for selecting an article image indicating the selected wearing mode from among a plurality of article images each indicating a different wearing mode for the article; and an output means for outputting, based on the person image and the selected article image, an output image including a wearing image indicating the article when the article is worn by the person in the selected wearing mode.

A virtual try-on method according to the present disclosure includes: acquiring a person image of a person performing virtual trying-on; receiving designation of an article; receiving a selection of a wearing mode for the article; selecting an article image indicating the selected wearing mode from among a plurality of article images each indicating a different wearing mode for the article; and outputting, based on the person image and the selected article image, an output image including a wearing image indicating the article when the article is worn by the person in the selected wearing mode.

A program according to the present disclosure causes a computer to execute processing including: acquiring a person image of a person performing virtual trying-on; receiving designation of an article; receiving a selection of a wearing mode for the article; selecting an article image indicating the selected wearing mode from among a plurality of article images each indicating a different wearing mode for the article; and outputting, based on the person image and the selected article image, an output image including a wearing image indicating the article when the article is worn by the person in the selected wearing mode. The program may be stored in a non-transitory recording medium that is readable by a computer.

### Advantageous Effects of Invention

According to the present disclosure, determination of whether an article is suitable for a person is facilitated.

### BRIEF DESCRIPTION OF DRAWINGS

FIG. 1 is a block diagram illustrating a configuration example of a virtual try-on system according to a first example embodiment.

FIG. 2 is a diagram illustrating an example of an article image.

FIG. 3 is a diagram illustrating an example of a person image.

FIG. 4 is a diagram illustrating an example of an output image displayed on a smart mirror.

FIG. 5 is a flowchart illustrating an operation example of the virtual try-on system.

FIG. 6 is a block diagram illustrating a configuration example of a virtual try-on system according to a second example embodiment.

FIG. 7 is a diagram illustrating an example of a screen including an output image.

FIG. 8 is a block diagram illustrating an example of a hardware configuration of a computer 500.

### MODE FOR CARRYING OUT THE INVENTION

### First Example Embodiment

A virtual try-on system 100 according to a first example embodiment outputs, to a smart mirror, a wearing image indicating an article when the article is worn by a person in front of the smart mirror in a certain wearing mode. This allows the person to look at the smart mirror and try various wearing modes for the article. In an example described below, a case where the smart mirror is installed in a store will be described as an example. However, a location of installing the smart mirror is not particularly limited.

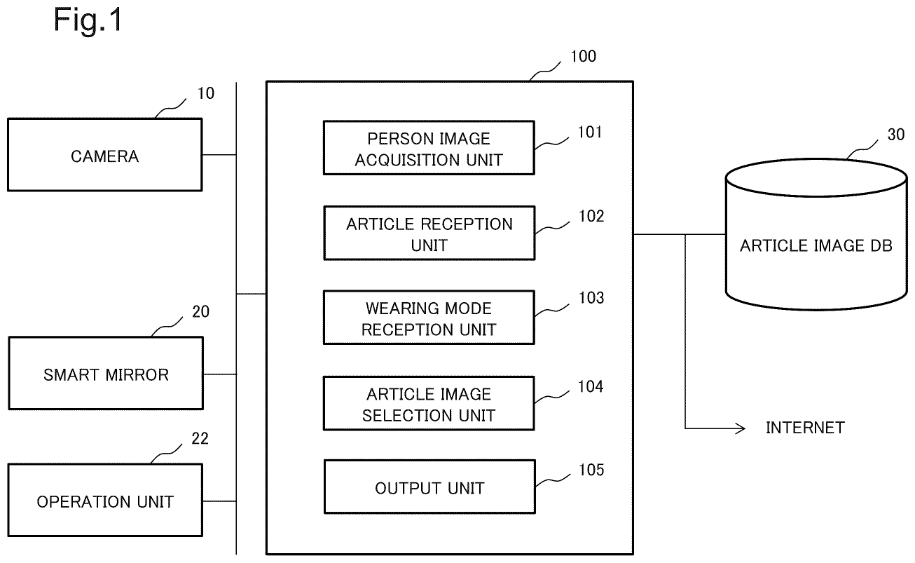

FIG. 1 is a block diagram illustrating a configuration example of the virtual try-on system 100 according to the first example embodiment. The virtual try-on system 100 includes a person image acquisition unit 101, an article reception unit 102, a wearing mode reception unit 103, an article image selection unit 104, and an output unit 105.

The virtual try-on system 100 is communicably coupled to a camera 10 and a smart mirror 20. The virtual try-on system 100 may be further communicably coupled to an article image database (DB) 30. The virtual try-on system 100 may be directly coupled to the camera 10, the smart mirror 20, and the article image DB 30 in a wired manner or via a network. The virtual try-on system 100 may be further coupled to the Internet.

The camera 10 photographs a person image of the person in front of the smart mirror 20. Therefore, the camera 10 is installed near the smart mirror 20. The camera 10 may be formed integrally with the smart mirror 20.

The smart mirror 20 has a mirror function and a display function. The smart mirror 20 is also called a mirror display. The smart mirror 20 is achieved, for example, by providing a mirror that partially transmits light in front of a display. Since an image displayed by the display is transmitted through the mirror, the person in front of the smart mirror 20 is able to see the image displayed by the display. In a region where the display does not display the image, the person is able to see a mirror image reflected by the mirror.

The smart mirror 20 may include an operation unit 22 to allow the person to operate the smart mirror 20 as necessary. A case where the smart mirror 20 includes a touch operation panel as the operation unit 22 will now be described below. However, an aspect of the operation unit 22 is not limited to this case. As the operation unit 22, the smart mirror 20 may be coupled to operation terminals such as a tablet and a smartphone in a wired or wireless manner. The smart mirror 20 may receive operations from these operation terminals.

The article image DB 30 is a database that stores article images. The article image DB 30 stores a plurality of article images indicating different wearing modes for each article. The article is not particularly limited as long as the article is worn by a person. Examples of the article include clothes, bags, hats, and clothing items.

Each of the wearing modes is a way of wearing an article in a different arrangement. Examples of the different wearing modes include, for example, a way of wearing an article by changing the front and the back or the inside and the outside of the article, and a way of wearing an article by changing a position of wearing the article on the body. It is possible to change the wearing mode for the article by changing unfastened buttons of the article in number, changing a way of tying a ribbon, and changing how much a hem is turned in width. When an article is worn in combination with another article, it is possible to further change a wearing mode for the article by changing a combination of articles or changing an order of overlapping the articles to be worn.

An appearance shape of an article when worn in one wearing mode is different from an appearance shape when worn in another wearing mode. Therefore, the article image DB 30 stores article images for a different wearing mode.

The article images stored in the article image DB 30 are, for example, images indicating wearing modes for products sold in stores and products sold so far. In this case, a business operator operating a store may register an article image. However, article images are not limited to this case. Article images to be registered may be images acquired by photographing articles by the user. Article images to be registered may be generated from images acquired by photographing articles by the user. A case where the user photographs an article will be described later.

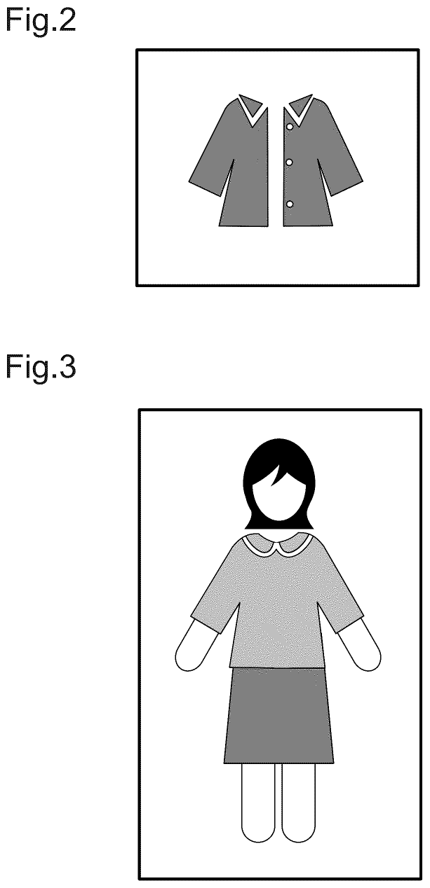

FIG. 2 is a diagram illustrating an example of an article image. The article image illustrated in FIG. 2 illustrates a wearing mode in which all buttons on the front side of a shirt are unfastened and the shirt is worn topmost when wearing clothes in a layered manner. The article image DB 30 may be stored with, in addition to the article image illustrated in FIG. 2, article images indicating other wearing modes for the same shirt. For example, an article image indicating a wearing mode in which a button is fastened, an article image indicating a wearing mode in which a sleeve is turned, and an article image indicating a wearing mode in which a cloth is worn under another cloth may be stored.

The person image acquisition unit 101 acquires a person image. For example, the person image acquisition unit 101 acquires, from the camera 10, a person image in which a person in front of the smart mirror 20 is photographed. The person image allows the physical appearance of a part or a whole of the body of the person to be recognized. A part of the body, which is to be recognized from the image, is the front side, the back side, the face, the upper body, the lower body, or the feet, for example, and it is possible to appropriately change the part in accordance with the installation positions of the smart mirror 20 and the camera 10. The person image further allows a position of the person with respect to the smart mirror 20 to be recognized. The person image may further allow an article worn by the person to be recognized.

FIG. 3 is a diagram illustrating an example of a person image. The person image illustrated in FIG. 3 includes the physical appearance of a whole of the body on the front side of a person.

The article reception unit 102 receives designation of an article. For example, the article reception unit 102 may receive designation of which article is to be virtually tried on based on an operation of the user. The user performs, on the operation unit 22, an operation of designating an article to be virtually tried-on from among optional articles displayed on the smart mirror 20 or the operation terminal. The article reception unit 102 receives designation of an article from the operation unit 22.

The wearing mode reception unit 103 receives a selection of a wearing mode for the article. For example, the wearing mode reception unit 103 may receive a selection of a wearing mode based on an operation of the user. The user performs, on the operation unit 22, an operation of selecting a wearing mode for virtual trying-on from among optional wearing modes displayed on the smart mirror 20 or the operation terminal. The wearing mode reception unit 103 receives a selection of a wearing mode from the operation unit 22.

The article image selection unit 104 selects an article image indicating the selected wearing mode from among a plurality of article images indicating different wearing modes for the article. For example, the article image selection unit 104 selects an article image relating to the wearing mode received by the wearing mode reception unit 103 from the plurality of article images stored in the article image DB 30.

The article image selection unit 104 may search, retrieve, and select an article image through the Internet. The article image selection unit 104 performs image retrieval, for example, to retrieve and acquire, from the Internet, an article image of the designated article. The article image selection unit 104 may acquire and select an article image generated in another non-illustrated image generation apparatus. The image generation apparatus generates, for example, a new article image indicating another wearing mode based on an article image indicating one wearing mode.

The article image selection unit 104 may select an article image from among article images including any of the article images stored in advance in the article image DB 30, article images searched and retrieved from the Internet, or generated article images. When there is no pre-registered article image indicating the selected wearing mode, the article image selection unit 104 may select an article image from among article images searched and retrieved from the Internet or generated article images.

The output unit 105 outputs an output image based on the person image acquired by the person image acquisition unit 101 and the article image selected by the article image selection unit 104. The output unit 105 outputs an output image including a wearing image indicating an article when the article is worn by the person in a selected wearing mode, for example. Based on a position of the person identified from the person image, the output unit 105 at this time outputs a wearing image in which the position of the body in the mirror image viewed by the person is aligned with the position of the displayed article.

The output unit 105 may output an article image as a wearing image. For example, the output unit 105 outputs an article image as a wearing image by displaying the article image at a position aligned with the body of the person. The output unit 105 may otherwise generate, from an article image, and output a wearing image. For example, the output unit 105 may output a wearing image generated by processing an article image in accordance with the body shape and the posture of a person, which are identified from a person image. The posture of a person includes a way the person is standing or a way the person is posing, or the orientation of the body with respect to the mirror.

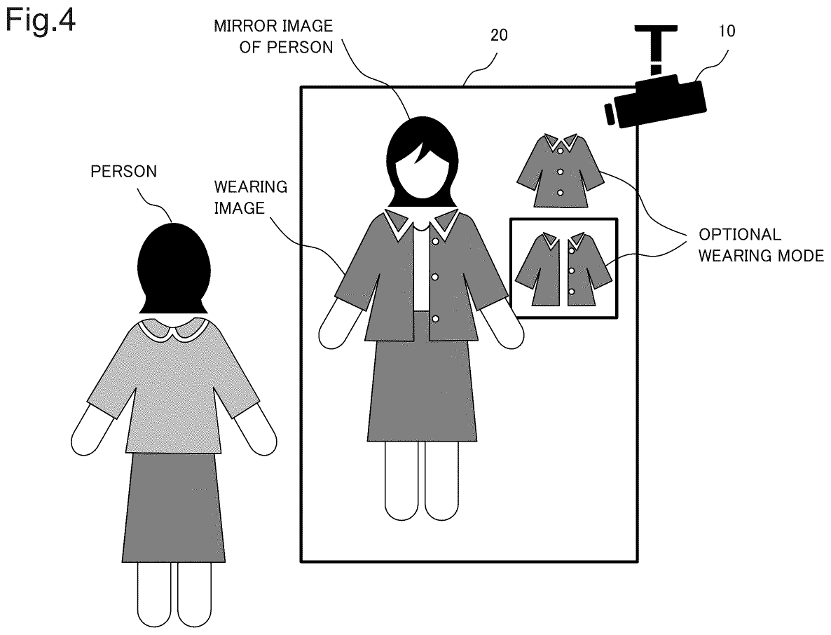

FIG. 4 is a diagram illustrating an example of an output image displayed on the smart mirror 20. A mirror image of a person in front of the smart mirror 20 is reflected on the smart mirror 20. The output unit 105 outputs a wearing image for a shirt, as an output image. As the output unit 105 displays the wearing image in accordance with the position and the body shape of the person, the person sees, in the image, as if the person is wearing the article.

The output unit 105 may further output an optional article. The optional article is represented by a letter or an image. The output unit 105 outputs an optional article to the smart mirror 20 or the operation terminal that is the operation unit 22.

The output unit 105 may output articles of a plurality of types, a plurality of sizes, or a plurality of color variations as options. The output unit 105 may output articles indicated in the article images stored in the article image DB 30 as options. The output unit 105 may output a product sold in the store or a product sold so far as an optional article.

The output unit 105 may output an article image indicating an article for which designation has been received, separately from a wearing image.

The output unit 105 may further output an optional wearing mode for an article for which designation has been received by the article reception unit 102. An optional wearing mode may be displayed by a letter representing the wearing mode. Optional wearing modes may otherwise be displayed by arranging article images indicating the wearing modes. The output unit 105 outputs an optional wearing mode to the smart mirror 20 or the operation terminal that is the operation unit 22.

An optional wearing mode may be determined in advance depending on a possible way of wearing for each article or each type of article.

The output unit 105 may output an optional wearing mode based on a wearing mode indicated by an article image that is acquirable by the article image selection unit 104 for a designated article. The output unit 105 may determine whether an article image is acquirable by the article image selection unit 104. Article images that are acquirable by the article image selection unit 104 include the article images stored in the article image DB 30, article images searched and retrieved through the Internet, and article images generated based on one article image. For a designated article, the output unit 105 may output an optional wearing mode relating to the wearing mode indicated in an article image stored in the article image DB 30, for example. Then, the output unit 105 does not allow an optional wearing mode, for which no article image is stored, to be displayed or to be selected by applying gray-out display.

As the output unit 105 outputs an option based on a wearing mode indicated in an acquirable article image, only an option relating to a wearing mode, for which the output unit 105 is possible to output a wearing image, is outputted. Therefore, the user is able to select a wearing mode from among wearing modes allowing naturally-looking wearing images to be outputted.

In FIG. 4, the smart mirror 20 displays article images indicating two wearing modes as optional wearing modes. The user selects one of the wearing modes via the operation unit 22 such as the touch operation panel. The smart mirror 20 may display a selected wearing mode in a different manner from another wearing mode based on control by the output unit 105. As illustrated in FIG. 4, for example, the smart mirror 20 displays a frame surrounding a selected wearing mode.

In FIG. 4, the case where virtual trying-on of one shirt is performed has been described as an example. However, virtual trying-on of a plurality of articles may be performed simultaneously. At this time, the article reception unit 102 receives designation of a plurality of articles. The wearing mode reception unit 103 may receive a selection of a wearing mode for each of the articles. The article image selection unit 104 selects an article image relating to a wearing mode of each of the articles. The output unit 105 outputs, based on a selected plurality of article images, output images including wearing images of the plurality of articles.

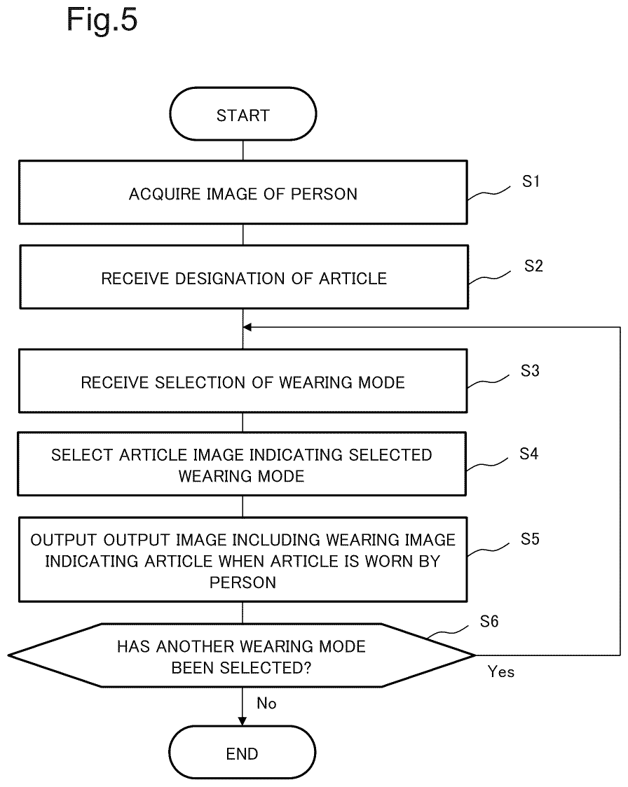

FIG. 5 is a flowchart illustrating an operation example of the virtual try-on system 100. The virtual try-on system 100 may, for example, start operation illustrated in FIG. 5 as a person is photographed in front of the smart mirror 20.

The person image acquisition unit 101 acquires a person image (step S1). The article reception unit 102 receives designation of an article (step S2). The wearing mode reception unit 103 receives a selection of a wearing mode for the article (step S3).

The article image selection unit 104 selects an article image indicating the selected wearing mode from among a plurality of article images indicating different wearing modes for the article (step S4).

Based on the acquired person image and the selected article image, the output unit 105 outputs an output image including a wearing image indicating the article when the article is worn by the person in the selected wearing mode (step S5).

After step S5, steps S3 to S5 may be repeated. For example, the wearing mode reception unit 103 determines whether another wearing mode is selected (step S6). When another wearing mode is selected (step S6: Yes), the wearing mode reception unit 103 receives the selection of the other wearing mode (step S3). The article image selection unit 104 selects an article image indicating the selected wearing mode (step S4). Then, the output unit 105 outputs a wearing image indicating a case where the article is worn by the person in the selected other wearing mode, instead of the original wearing image (step S5). When no other wearing mode is selected (step S6: No), the virtual try-on system 100 thus ends the operation of FIG. 5.

After step S5, the article reception unit 102 may receive designation of another article. When another article is designated, steps S2 to S5 are repeated. The article reception unit 102 may receive designation of another article as an additional article. The article reception unit 102 may otherwise cancel the designation of the previously designated article and receive designation of another article.

After step S5, the article reception unit 102 may also receive deletion of the article.

According to the first example embodiment, the person image acquisition unit 101 acquires a person image, the article reception unit 102 receives designation of an article, and the wearing mode reception unit 103 receives a selection of a wearing mode for the article. Then, the article image selection unit 104 selects an article image indicating the selected wearing mode from among a plurality of article images indicating different wearing modes for the article. Based on the acquired person image and the selected article image, the output unit 105 outputs an output image including a wearing image indicating the article when the article is worn by the person in the selected wearing mode. Therefore, virtual trying-on in various wearing modes for the article is achieved. Determination of whether an article is suitable for a person is thus facilitated.

When only one wearing mode is allowed to be tried in virtual trying-on, the person does not always wear an article in the wearing mode. According to the first example embodiment, it is possible to perform virtual trying-on in a wearing mode considered to be actually applied by a person when wearing an article, making it possible to support determination of whether the article is suitable for the person. There is a case where it is difficult to determine whether an article is suitable for a person only by trying one wearing mode. According to the first example embodiment, it is possible to support determination of whether an article is suitable for a person by taking into account various wearing modes.

The article image selection unit 104 selects an article image indicating the selected wearing mode from among a plurality of article images indicating different wearing modes for the article, and the output unit 105 outputs an output image based on the selected article image. Therefore, the output unit 105 is allowed to output an output image representing an appearance of an article, which differs depending on a wearing mode. Therefore, the first example embodiment allows appearances of an article in various wearing modes to be presented to a person more easily, as compared with a case where no article image is selected for each wearing mode.

When the virtual try-on system 100 according to the first example embodiment is introduced for virtual trying-on at a store, a customer is allowed to easily try on an article including a product. The customer is able to grasp appearances of wearing one article in various arrangements. According to the first example embodiment, it is therefore possible to urge a customer to purchase a product.

### Second Example Embodiment

A virtual try-on system 200 according to a second example embodiment outputs, to the display, a wearing image indicating an article when the article is worn by a person in a certain wearing mode. The user viewing the display is thus able to view the display and try various wearing modes for the article.

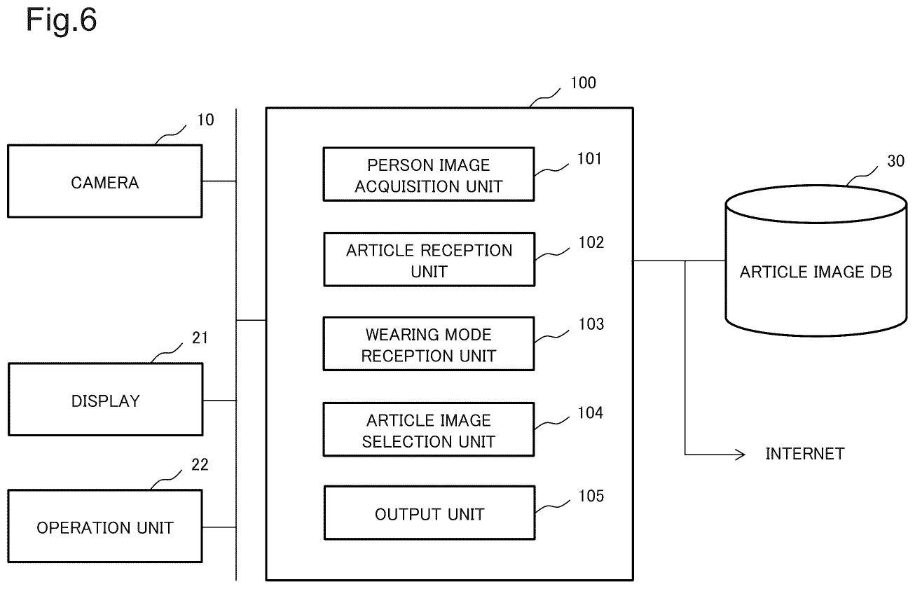

FIG. 6 is a block diagram illustrating a configuration example of the virtual try-on system 200 according to the second example embodiment. For configurations in the virtual try-on system 200, those similar to the configurations in the virtual try-on system 100 according to the first example embodiment will be omitted. In FIG. 6, the virtual try-on system 200 is different from the virtual try-on system 100 according to the first example embodiment in that it is coupled to a display 21, instead of the smart mirror 20.

The display 21 is not particularly limited as long as a user is able to confirm an output image outputted from the output unit 105. For example, the display 21 may be a signage installed in a store. It is also possible to utilize the smart mirror 20 according to the first example embodiment as the display 21 in the second example embodiment. The display 21 may be a smartphone, a tablet, or a head-mounted display.

The virtual try-on system 200 is communicably coupled to the camera 10 and the operation unit 22 as necessary. The camera 10 and the operation unit 22 may be provided integrally with the display 21 or may be achieved as separate devices. The camera 10 may be installed to photograph the front of a person facing the display 21 serving as a signage, but its installation position is not limited to this case. For example, the camera 10 may be installed to photograph the back of the person facing the display 21.

The person image acquisition unit 101 acquires a person image of a person performing virtual trying-on. The person image acquisition unit 101 acquires a person image in which it is possible to recognize the physical appearance of a part or a whole of the body of the person.

In one example, the person image acquisition unit 101 acquires a person image from the camera 10. For example, the person image acquisition unit 101 acquires a person image in which a person standing in front of the display 21 serving as a signage is photographed. The person image acquisition unit 101 may acquire an image of a person photographed by the camera 10 included in the display 21 serving as a smartphone.

However, a specific method of acquiring a person image is not particularly limited. In another example, the person image acquisition unit 101 may acquire a person image photographed in advance. That is, in the second example embodiment, the camera 10 may be provided as necessary.

Similar to the first example embodiment, the output unit 105 outputs, to the display 21, an output image including a wearing image based on a person image and a selected article image. However, in the second example embodiment, the output unit 105 outputs an output image including a person image and a wearing image. The output unit 105 outputs an output image in which a wearing image indicating an article when the article is worn by a person in a selected wearing mode is superimposed on a person image, for example.

The output unit 105 may output, to the display 21, an output image including a person image and a wearing image, which are left-right flipped. An identical figure to the figure of the user seeing themselves in the mirror is outputted to the display 21. By outputting such an output image to the display 21 serving as a signage installed in a store, the user is able to use the display 21 as a mirror.

The output unit 105 may output an output image in accordance with the orientation of a person in a person image. When a person image is an image acquired by photographing the back side of a person, the output unit 105 outputs an output image indicating the back of the person wearing an article in a selected wearing mode. The user is thus able to easily confirm, through the display 21, the back of themselves in the selected wearing mode, which is not possible to be confirmed with the mirror.

The virtual try-on system 200 may include an identification unit that identifies the orientation of a person in a person image. In this case, the output unit 105 outputs an output image based on a result of identification, by the identification unit, of the orientation of the person. For example, the identification unit identifies the orientation of the legs or the face from a person image and identifies the orientation of the person. The identification unit may identify the orientation of a person in a person image based on a relationship between the installation positions of the camera 10 that has photographed the person image and the display 21 serving as a signage. The identification unit identifies that the image photographed by the camera 10 installed at the position facing the display 21 is an image acquired by photographing the back of a person.

The output unit 105 may output an output image in which an article image is superimposed on a person image to serve as a wearing image. For example, the output unit 105 outputs an article image as a wearing image by displaying the article image at a position aligned with the body in a person image. The output unit 105 may otherwise output a wearing image acquired by processing an article image in accordance with the body shape and the posture of a person in a superimposed manner on a person image.

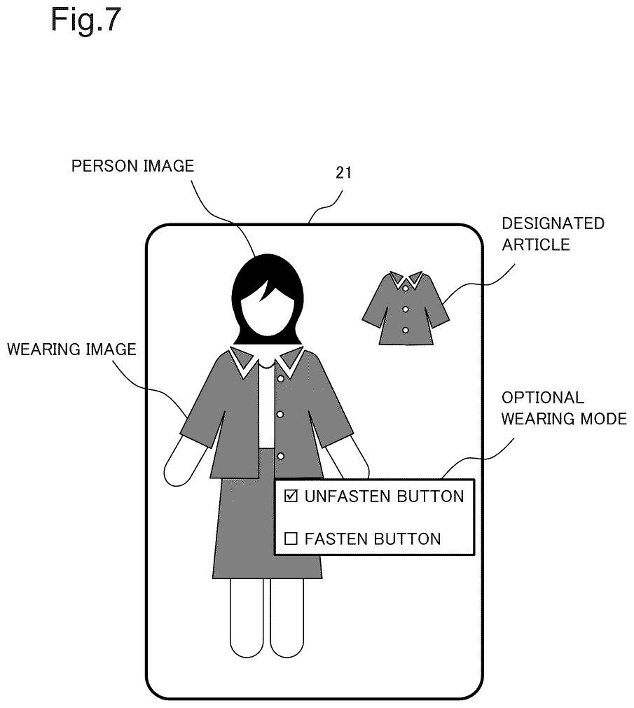

FIG. 7 is a diagram illustrating an example of a screen including an output image, which is displayed on the display 21. For example, as illustrated in FIG. 7, the output unit 105 outputs an output image in which the article image illustrated in FIG. 2 is superimposed as a wearing image at a position aligned with the body in the person image illustrated in FIG. 3.

The screen illustrated in FIG. 7 further includes an image indicating a designated article. The screen illustrated in FIG. 7 also includes optional wearing modes. In FIG. 7, an optional wearing mode of unfastening a button and an optional wearing mode of fastening the button are displayed, and it is indicated, with one of check boxes, that the wearing mode of unfastening the button is selected. A display mode of an option is not limited to that described above, and, for example, options may be displayed in a pull-down manner.

According to the second example embodiment, virtual trying-on in various wearing modes for an article is achieved, similar to the first example embodiment. According to the second example embodiment, the output unit 105 outputs an output image including a person image and a wearing image. The user is thus able to view the display 21 to try various wearing modes for an article.

When the display 21 is installed in a store, the second example embodiment makes it possible to urge a customer to purchase a product, similar to the first example embodiment. When a user owns the display 21, the user is able to try various wearing modes for an article at any place such as home.

### Modification Examples

It is possible to modify the virtual try-on systems 100 and 200 according to the example embodiments as described below, for example.

In one modification example, the virtual try-on systems 100 and 200 may further include a specification unit that specifies which user a person for whom a person image has been acquired is. At this time, the article image DB 30 stores an article image of an article owned by the user. For example, the article image DB 30 stores an article image for each user. The article reception unit 102 extracts an article owned by the user specified by the specification unit from the article image DB 30. The article reception unit 102 causes the output unit 105 to output the extracted article as an optional article. In this way, the article reception unit 102 may receive designation of an article from among articles owned by the user. A method of how to specify a person is not particularly limited, and a person may be specified through face authentication using a person image, for example. A person may be specified using a member code carried by the person.

As the article reception unit 102 receives designation of an article owned by a person for whom a person image has been acquired, the output unit 105 is able to output a wearing image when the article owned by the person is worn in a selected wearing mode. For example, when a person is actually trying on a cloth sold in a store, the output unit 105 is able to output a wearing image indicating a cloth that the person is storing in the house. The output unit 105 is able to output an output image including a wearing image of a sold product and a wearing image of a cloth stored in the house. As described above, the virtual try-on systems 100 and 200 are able to present, to the customer, an appearance when a cloth sold in a store and a cloth stored in the house are combined with each other.

In one modification example, the article reception unit 102 may receive designation of an article based on a person image acquired by the person image acquisition unit 101.

The article reception unit 102 may receive designation of an article in accordance with a range of the body identified from a person image. At this time, the virtual try-on systems 100 and 200 may further include an identification unit that identifies that which part of a person has been photographed in an image that is the person image. For example, the article reception unit 102 may stop receiving of designation of an article to be worn on a part that is not identified by the identification unit from a person image. When a person image is an image acquired by photographing the upper body of a person, the identification unit does not identify the feet of the person. Therefore, the article reception unit 102 stops receiving of designation of shoes. The article reception unit 102 may cause the output unit 105 to output a warning when an article to be worn on a part other than the part identified by the identification unit is designated. The article reception unit 102 may cause the output unit 105 to output an optional article by excluding, from options, an article for which reception is to be canceled. The article reception unit 102 may otherwise cause the output unit 105 to output an optional article by displaying an article for which reception is to be canceled in a gray-out manner.

The virtual try-on systems 100 and 200 may further include an identification unit that identifies an article actually worn by a person through image recognition of a person image. The identification unit may identify an article by collating a pre-registered article image with a person image. Then, the article reception unit 102 receives designation of the identified article as a designated article. The article reception unit 102 may cause the output unit 105 to output the identified article as an optional article.

The virtual try-on systems 100 and 200 may further include an identification unit that identifies a wearing mode of an article actually worn by a person based on a person image. Then, the wearing mode reception unit 103 may cause the output unit 105 to output an optional wearing mode by excluding, from options, the wearing mode of actual wearing by the person. The wearing mode reception unit 103 may otherwise cause the output unit 105 to output an optional wearing mode by displaying a wearing mode of actual wearing by the person in a gray-out manner. In this way, the wearing mode reception unit 103 receives a selection of a wearing mode different from a wearing mode of actual wearing by a person.

When the article reception unit 102 receives designation of an article actually worn by the person, as described above, the output unit 105 is able to output a wearing image when the article worn by the person is worn in another wearing mode. Therefore, for an article already worn by the person, other wearing modes are allowed to be easily tried without putting on and off the article or unfastening and fastening a button of the article.

The article reception unit 102 may receive designation of a plurality of articles including an article actually worn by a person performing virtual trying-on and an article not worn by the person. For example, when a person is actually wearing a shirt by fastening a button of the shirt, there is a case where the person desires to confirm an appearance when another article is worn under the shirt by unfastening the button of the shirt. At this time, the output unit 105 may output an output image including a wearing image of an article that is not worn by the person and a wearing image indicating an article that is worn by the person. At this time, the output unit 105 is able to output a wearing image indicating a wearing mode different from a wearing mode of the actually worn article. For example, when a person is wearing a shirt with its button fastened, the output unit 105 outputs a wearing image with the button unfastened. Therefore, when an article that is not worn is to be further worn, a user is able to easily try an appearance of wearing by changing a wearing mode of the actually worn article.

When an article is recommended to be worn for combined wearing of an article worn by a person and the article, the article reception unit 102 may receive designation of the article as a designated article. At this time, the virtual try-on systems 100 and 200 may further include an identification unit that identifies an article worn by a person from a person image and a determination unit that determines a recommended article. The determination unit determines an article recommended to be worn in combination with an identified article with a desired method. The determination unit may determine a recommended article from among articles that the user is storing in the home. For example, the determination unit may refer to a database in which a combination of recommended articles has been registered in advance. The determination unit may determine an article that is suitable for an article being worn based on the shape or the color of the article using artificial intelligence (AI).

The article reception unit 102 may receive designation of the article by using the determined article as an article designated as is based on a result of the determination by the determination unit. The article reception unit 102 may otherwise receive designation of an article based on a selection of the user from among articles determined by the determination unit. The output unit 105 may output, as options, articles determined to be recommended to be worn in combination with the identified article. For example, the output unit 105 outputs an output image including a wearing image when the designated article is worn in the selected wearing mode. Then, the article reception unit 102 receives designation of an article selected from among the options.

The wearing mode reception unit 103 may receive a selection of a wearing mode recommended for wearing in combination with an article worn by the person. The output unit 105 may output the recommended wearing mode as an option. The recommended wearing mode may be determined in advance in accordance with a combination of articles.

In one modification example, the article reception unit 102 may receive designation of an article based on a result of reading of a tag attached to an article. In this case, a tag reader is communicably coupled to the smart mirror 20 or the display 21. A tag attached to an article is not particularly limited as long as the article is identified from the tag, and is, for example, a tag on which a code including a barcode and a two-dimensional code is printed or a radio frequency (RF) tag. The article reception unit 102 receives designation of an article based on a result of reading by the tag reader. The article reception unit 102 receives designation of the article based on the result of reading of the tag attached to the article, allowing the user to easily designate the article to be virtually tried-on.

When a plurality of articles have been recognized through image recognition from a person image and when tags of the plurality of articles are read through the method described above, the output unit 105 may output the plurality of articles as optional articles. The article reception unit 102 receives designation of an article selected through an operation of the user.

In one modification example, the virtual try-on systems 100 and 200 may further include an image generation unit that generates an article image indicating another wearing mode from an article image indicating a wearing mode. The image generation unit generates an article image by processing an article image stored in the article image DB 30 or an article image searched and retrieved through the Internet. The image generation unit may generate a three-dimensional model image as an article image from an image acquired through a desired method. For example, the image generation unit generates an article image indicating a mode of wearing by unfastening a button from an article image indicating a mode of wearing by fastening the button. When there is no pre-registered article image indicating a selected wearing mode, the image generation unit may generate an article image indicating the wearing mode.

When the article reception unit 102 receives designation of an article, as a designated article, which is an article actually worn by the person, the image generation unit may generate an article image based on a person image. That is, the image generation unit extracts, from the person image, an article image indicating a wearing mode in accordance with which the person is actually wearing the article. Then, the image generation unit generates an article image indicating another wearing mode based on the extracted article image.

The article image selection unit 104 may in this way select an article image from among article images including article images generated by the image generation unit. The article image selection unit 104 may select an article image from two images that are an article image extracted from a person image and an image generated by the image generation unit. As the image generation unit generates an article image, it is possible to output a wearing image even when there is no appropriate article image in the article image DB 30 or when no appropriate article image is searched and retrieved through the Internet.

In the first example embodiment, it has been described that there is a case where an article image is to be registered in the article image DB 30 based on an image captured by the user. In the article image DB 30, an article image indicating a wearing mode for an article, which is generated from an image acquired as the user has photographed the article may be registered. For example, when the user has photographed an image photographed in a state where a person is wearing an article, the image may be registered as an article image. When the user has photographed a placement image in a state where an article is placed flat without being worn, an article image may also be generated by processing the image.

The user photographs an image of an owning article and registers an article image. When an article image is registered based on an image photographed by the user, the article image is stored for an article that is not sold in a store. This enables virtual trying-on of various articles.

However, when an article image is to be registered based on images photographed by the user, a number of the images photographed by the user may be insufficient, or the quality of the images may be insufficient. When the number and the quality of the images photographed by the user are insufficient, it may be difficult to generate an article image, and there may be insufficiency in article image.

The cases where the number of images photographed by the user is insufficient and the quality of the images is poor include cases where captured images are too bright and too dark. When images acquired by photographing an article in a plurality of directions are required for generating an article image, and, if there is only an image photographed in one direction, there may be insufficiency in article image. When it is impossible to generate an article image indicating a wearing mode from a placement image, and, if there is only a placement image photographed, there may be insufficiency in article image.

As described above, the article image selection unit 104 may select an article image retrieved and acquired from the Internet when there is insufficiency in pre-registered article image indicating a selected wearing mode. The article image selection unit 104 may determine that there is insufficiency in article image registered in advance. The article image selection unit 104 may perform image retrieval from the Internet to acquire article images of identical articles or similar articles in appearance.

Meanwhile, for a certain article, a plurality of article images indicating a similar or identical wearing mode in type may be registered in the article image DB 30. For example, when stylists or users register article images, the plurality of stylists may register article images indicating a similar or identical wearing mode in type. It is considered that the more the article images indicating a similar or identical wearing mode in type, the more the degree of recommendation for the wearing mode.

Therefore, in one modification example, the virtual try-on systems 100 and 200 may further include a determination unit that determines a recommended wearing mode. The determination unit determines a recommended wearing mode based on the number of article images indicating a similar or identical wearing mode in type for a designated article. For example, the determination unit determines that a wearing mode for which the number of article images indicating a similar or identical wearing mode in type is largest is the recommended wearing mode.

The method through which the determination unit determines a recommended wearing mode is not limited to the method described above. For example, the determination unit may determine a wearing mode suitable for the person in accordance with the physical appearance of the person. For example, the determination unit may determine a recommended wearing mode in accordance with the height of the person.

The output unit 105 may output an optional, recommended wearing mode in a different manner from other options. The wearing mode reception unit 103 receives a selection of a determined recommended wearing mode. The output unit 105 is thus able to output a wearing image indicating the recommended wearing mode.

The output unit 105 may output, to the smart mirror 20, both an output image according to the first example embodiment and an output image according to the second example embodiment. For example, the output unit 105 outputs a wearing image according to the first example embodiment in a superimposed manner on a mirror image of a person reflected on the smart mirror 20 to indicate an appearance of an article on the side facing the smart mirror 20. The output unit 105 may further output a wearing image and a person image according to the second example embodiment by shifting a mirror image of the person to indicate an appearance of an article on the back side of the person, which does not appear on the mirror of the smart mirror 20. The user is thus able to simultaneously check the appearances of the front side and the back side.

### [Hardware Configuration]

In each of the example embodiments described above, each of the components in the virtual try-on systems 100 and 200 represents a block in functional unit. Some or all of the components in the virtual try-on systems 100 and 200 may be achieved by a desired combination of a computer 500 and a program.

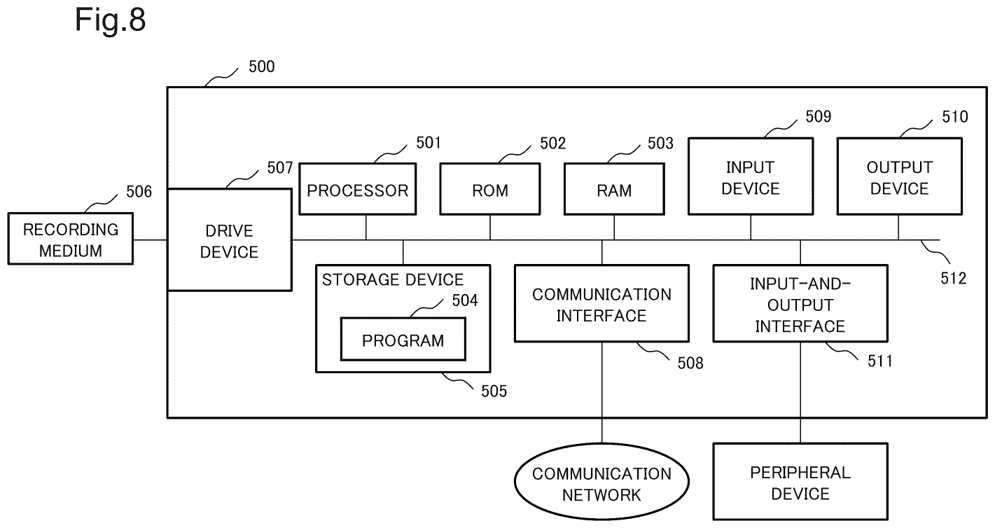

FIG. 8 is a block diagram illustrating an example of a hardware configuration of the computer 500. Referring to FIG. 8, the computer 500 includes, for example, a processor 501, a read only memory (ROM) 502, a random access memory (RAM) 503, programs 504, a storage device 505, a drive device 507, a communication interface 508, an input device 509, an input-and-output interface 511, and a bus 512.

The processor 501 wholly controls the computer 500. An example of the processor 501 includes a central processing unit (CPU), for example. The processor 501 is not particularly limited in number, and there are one or more processors 501.

The programs 504 include instructions for achieving functions of the virtual try-on systems 100 and 200. The programs 504 are stored in advance in the ROM 502, the RAM 503, and the storage device 505. The processor 501 achieves the functions of the virtual try-on systems 100 and 200 by executing the instructions included in the programs 504. The RAM 503 may store data to be processed by each of the functions of the virtual try-on systems 100 and 200.

The drive device 507 performs reading and writing from and into a recording medium 506. The communication interface 508 provides an interface with a communication network. The input device 509 includes a mouse and a keyboard, and receives an input of information from the user, for example. An output device 510 is a display, and outputs (displays) information to the user, for example. The input-and-output interface 511 provides an interface with a peripheral device. The bus 512 couples the components in the hardware to each other. The programs 504 may be supplied to the processor 501 via the communication network, or may be stored in the recording medium 506 in advance, read by the drive device 507, and supplied to the processor 501.

The hardware configuration illustrated in FIG. 8 is a mere example, other components than the components may be added, and some of the components may not be included.

There are various modification examples on how to achieve the virtual try-on systems 100 and 200. For example, the virtual try-on systems 100 and 200 may be achieved by a desired combination of a computer and a program, which is different for each component. The plurality of components included in the virtual try-on systems 100 and 200 may be achieved by a desired combination of one computer and a program.

Some or all of the components in the virtual try-on system 100 may be achieved by the smart mirror 20 or the display 21. That is, programs that achieve the components in the virtual try-on system 100 may be installed in a computer in the smart mirror 20 or the display 21. For example, the person image acquisition unit 101 and the output unit 105 may be achieved by the smart mirror 20 or the display 21. The others of the components may be achieved by a server device separate from the smart mirror 20 or the display 21.

At least a part of the virtual try-on systems 100 and 200 may be provided in a format called software as a service (SaaS). That is, at least some of the functions for achieving the virtual try-on systems 100 and 200 may be executed through software that is executed via a network.

While the present invention has been particularly shown and described with reference to the example embodiments described above, the present invention is not limited to these example embodiments. Various modification examples that can be understood by those skilled in the art can be made to the configuration and details of the present disclosure within the scope of the present disclosure. The configurations in the example embodiments can be combined with each other without departing from the scope of the present disclosure.

This application is based upon and claims the benefit of priority from Japanese patent application No. 2022-134306, filed on Aug. 25, 2022, the disclosure of which is incorporated herein in its entirety by reference.

Although some or all of the example embodiments described above can be described as supplementary notes described below, the present invention is not limited to the supplementary notes described below.

### [Supplementary Note 1]

A virtual try-on system including:
a person image acquisition means for acquiring a person image of a person performing virtual trying-on;
an article reception means for receiving designation of an article;
a wearing mode reception means for receiving a selection of a wearing mode for the article;
an article image selection means for selecting an article image indicating the selected wearing mode from among a plurality of article images each indicating a different wearing mode for the article; and
an output means for outputting, based on the person image and the selected article image, an output image including a wearing image indicating the article when the article is worn by the person in the selected wearing mode.

### [Supplementary Note 2]

The virtual try-on system described in Supplementary Note 1, in which
each of the wearing modes is a way of wearing the article in a different arrangement.

### [Supplementary Note 3]

The virtual try-on system described in Supplementary Note 1 or 2, in which
the output means outputs an optional wearing mode based on the wearing mode indicated by the article image that is acquirable for the designated article.

### [Supplementary Note 4]

The virtual try-on system described in Supplementary Note 1 or 2, further including
an image generation means for generating the article image indicating another wearing mode from the article image indicating one wearing mode,
in which the article image selection means selects the generated article image.

### [Supplementary Note 5]

The virtual try-on system described in Supplementary Note 1 or 2, in which
the article reception means receives designation of the article, the article being identified from the person image, as the designated article, and
the wearing mode reception means receives a selection of a wearing mode different from a wearing mode of the article identified from the person image.

### [Supplementary Note 6]

The virtual try-on system described in Supplementary Note 1 or 2, further including
a determination means for determining an article recommended to be worn in combination with the article identified from the person image,
in which the article reception means receives designation of the article, the article being recommended, as the designated article.

### [Supplementary Note 7]

The virtual try-on system described in Supplementary Note 1 or 2, further including
a determination means for determining a recommended wearing mode based on a number of the article images indicating a similar or identical wearing mode in type for the article,
in which the wearing mode reception means receives a selection of the determined recommended wearing mode.

### [Supplementary Note 8]

The virtual try-on system described in Supplementary Note 1 or 2, in which
the person image acquisition means acquires the person image of the person in front of a smart mirror, and
the output means outputs the output image to the smart mirror.

### [Supplementary Note 9]

A virtual try-on method including:
acquiring a person image of a person performing virtual trying-on;
receiving designation of an article;
receiving a selection of a wearing mode for the article;
selecting an article image indicating the selected wearing mode from among a plurality of article images each indicating a different wearing mode for the article; and
outputting, based on the person image and the selected article image, an output image including a wearing image indicating the article when the article is worn by the person in the selected wearing mode.

### [Supplementary Note 10]

A program for causing a computer to execute processing including:
acquiring a person image of a person performing virtual trying-on;
receiving designation of an article;
receiving a selection of a wearing mode for the article;
selecting an article image indicating the selected wearing mode from among a plurality of article images each indicating a different wearing mode for the article; and
outputting, based on the person image and the selected article image, an output image including a wearing image indicating the article when the article is worn by the person in the selected wearing mode.

### REFERENCE SIGNS LIST

100, 200 Virtual try-on system
101 Person image acquisition unit
102 Article reception unit
103 Wearing mode reception unit
104 Article image selection unit
105 Output unit
10 Camera
20 Smart mirror
21 Display
22 Operation unit
30 Article image DB

What is claimed is:

1. A virtual try-on system comprising:
at least one memory configured to store instructions; and
at least one processor configured to execute the instructions to:
acquire a person image of a person performing virtual trying-on;
receive designation of an article;
receive a selection of a wearing mode for the article;
select an article image indicating the selected wearing mode from among a plurality of article images each indicating a different wearing mode for the article; and
output, based on the person image and the selected article image, an output image including a wearing image indicating the article when the article is worn by the person in the selected wearing mode.

2. The virtual try-on system according to claim 1, wherein
each of the wearing modes is a way of wearing the article in a different arrangement.

3. The virtual try-on system according to claim 1, wherein the at least one processor is further configured to execute the instructions to:
output an optional wearing mode based on the wearing mode indicated by the article image that is acquirable for the designated article.

4. The virtual try-on system according to claim 1, wherein the at least one processor is further configured to execute the instructions to:
generate the article image indicating another wearing mode from the article image indicating one wearing mode; and
select the generated article image.

5. The virtual try-on system according to claim 1, wherein the at least one processor is further configured to execute the instructions to:
identify an article from the person image;
receive the article identified from the person image, as the designated article, and
receive a selection of a wearing mode different from a wearing mode of the article identified from the person image.

6. The virtual try-on system according to claim 1, wherein the at least one processor is further configured to execute the instructions to:
identify an article from the person image;
determine an article recommended to be worn in combination with the article identified from the person image; and
receive the article recommended, as the designated article.

7. The virtual try-on system according to claim 1, wherein the at least one processor is further configured to execute the instructions to:
determine a recommended wearing mode based on a number of the article images indicating a similar or identical wearing mode in type for the article; and
receive a selection of the recommended wearing mode.

8. The virtual try-on system according to claim 1, wherein the at least one processor is further configured to execute the instructions to:
acquire the person image of the person in front of a smart mirror, and
output the output image to the smart mirror.

9. A virtual try-on method comprising:
acquiring a person image of a person performing virtual trying-on;
receiving designation of an article;
receiving a selection of a wearing mode for the article;
selecting an article image indicating the selected wearing mode from among a plurality of article images each indicating a different wearing mode for the article; and
outputting, based on the person image and the selected article image, an output image including a wearing image indicating the article when the article is worn by the person in the selected wearing mode.

10. A recording medium that non-transiently records a program for causing a computer to execute processing comprising:
acquiring a person image of a person performing virtual trying-on;
receiving designation of an article;
receiving a selection of a wearing mode for the article;
selecting an article image indicating the selected wearing mode from among a plurality of article images each indicating a different wearing mode for the article; and
outputting, based on the person image and the selected article image, an output image including a wearing image indicating the article when the article is worn by the person in the selected wearing mode.
